(19) United States
(12) Patent Application Publication
(10) Pub. No.: US 2023/0145493 A1
(43) Pub. Date: May 11, 2023

(54) RELAY DEVICE, COMMUNICATION CONTROL METHOD, AND RECORDING MEDIUM RECORDING COMMUNICATION PROGRAM

(71) Applicant: TOYOTA JIDOSHA KABUSHIKI KAISHA, Toyota-shi (JP)

(72) Inventors: Hiroya MATSUMOTO, Toyota-shi (JP); Yoshiroh HIRATA, Toyota-shi (JP); Hiroshi OTA, Nagoya-shi (JP)

(73) Assignee: TOYOTA JIDOSHA KABUSHIKI KAISHA, Toyota-shi (JP)

(21) Appl. No.: 17/943,951

(22) Filed: Sep. 13, 2022

(30) Foreign Application Priority Data
Nov. 5, 2021 (JP) 2021-181157

(51) Int. Cl. H04L 41/0686; H04L 1/00

(52) U.S. Cl. CPC H04L 41/0686; H04L 1/0002

(57) ABSTRACT

A relay device that is configured to: perform reset processing in relation to wired communication with a first device in response to a change in a communication rate of the wired communication with the first device; and in response to performing the reset processing, make a request to a second device to suppress processing relating to fault detection that detects cases in which communication between the second device and the first device is not possible.

### CROSS-REFERENCE TO RELATED APPLICATION

This application is based on and claims priority under 35 USC 119 from Japanese Patent Application No. 2021-181157 filed on Nov. 5, 2021, the disclosure of which is incorporated by reference herein.

### BACKGROUND

### Technical Field

The present disclosure relates to a relay device, a communication control method, and a recording medium recording a communication program.

### Related Art

In a local area network (LAN) standard such as Ethernet (registered trademark) or the like, a communication rate can be switched. Japanese Patent Application Laid-Open (JP-A) No. 2005-086642 discloses a technology that, during or after establishment of a connection, switches a transfer rate when a cumulative amount of communication errors reaches a threshold value or greater. JP-A No. 2011-124641 discloses a technology that conducts autonegotiation in a suitable range of communication rates without a user being aware of how categories of LAN cables match the communication rates.

Reset processing of a communication device is performed when a communication rate is to be switched. However, when reset processing of a communication device is performed, communication with the communication device is temporarily not possible. When another communication device is conducting communication with the communication device performing the reset processing but no messages reach the another communication device from the communication device performing the reset processing, the another communication device may detect an error.

### SUMMARY

An aspect of the present disclosure is a relay device that includes a memory, and a processor coupled to the memory, the processor being configured to: perform reset processing in relation to wired communication with a first device in response to a change in a communication rate of the wired communication with the first device; and in response to performing the reset processing, make a request to a second device to suppress processing relating to fault detection that detects cases in which communication between the second device and the first device is not possible.

### BRIEF DESCRIPTION OF DRAWINGS

FIG. 1 is a diagram describing an example of a situation in which a communication rate in a LAN standard is switched.

FIG. 2 is a diagram showing an example of schematic structures of a communication system according to an exemplary embodiment of the disclosure.

FIG. 3 is a block diagram showing an example of functional structures of a relay device and ECUs.

FIG. 4 is a flowchart showing an example of flows of communication processing by the relay device and ECUs.

FIG. 5 is a flowchart showing an example of flows of communication processing by the relay device and ECUs.

### DETAILED DESCRIPTION

—Circumstances—

To facilitate understanding of an exemplary embodiment of the present disclosure, first, the circumstances in which the exemplary embodiment of the present disclosure was reached are described.

In a LAN standard such as Ethernet or the like, a communication rate can be switched. For example, when communication errors are occurring, the communication rate is switched so as to lower the communication rate in order to prevent communication errors, and when the situation returns to normal, the communication rate is switched to restore the original communication rate.

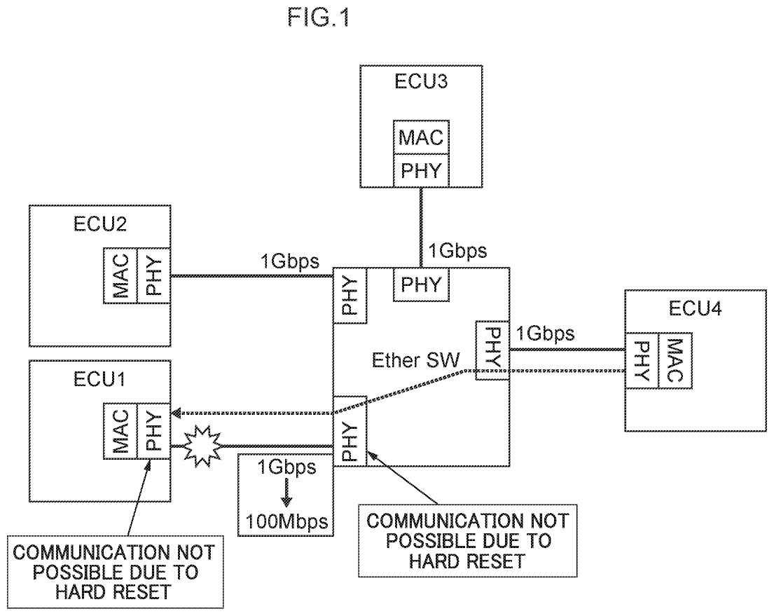

FIG. 1 is a diagram describing a situation in which a communication rate in a LAN standard is switched. FIG. 1 depicts a situation in which four electronic control units (ECUs) are connected to an Ethernet switch (Ether SW). The four ECUs are denoted as, respectively, ECU1 to ECU4. When communication errors occur between the Ethernet switch and ECU1, due to external noise superimposing on a communication line between the Ethernet switch and ECU1 or the like, the communication rate between the Ethernet switch and ECU1 is lowered in order to reduce the error rate. When the communication rate is to be lowered, the Ethernet switch and the ECU1 turn off autonegotiation and execute reset processing. The reset processing at the Ethernet switch is conducted only for a port that is connected to ECU1. When the reset processing has been completed, the Ethernet switch and ECU1 conduct communications at a low rate. For example, usual communication between the Ethernet switch and ECU1 is conducted at 1 Gbps, and when the communication rate is switched to a low rate, communication is conducted at 100 Mbps.

In order to switch the communication rate between the Ethernet switch and ECU1 in this manner, it is necessary to turn off autonegotiation and perform the reset processing. However, while the reset processing is being performed at the Ethernet switch and ECU1, communications cannot be conducted between ECU1 and the other ECUs. Therefore, ECU2 to ECU4 cannot communicate with ECU1 while the reset processing is being performed at the Ethernet switch and ECU1. Thus, messages expected in communications with ECU1 are not sent, and ECU2 to ECU4 may detect ECU1 as being faulty.

Accordingly, the inventors of the present disclosure have conducted diligent investigations into technologies for, while reset processing is being performed at a communication device and a relay device in order to switch a communication rate, suppressing a case of the communication device that is conducting the reset processing being detected as faulty by another communication device. As a result, the inventors of the present disclosure have succeeded in devising a technology that, as described below, suppresses a case of another communication device detecting a communication device that is performing reset processing as being faulty.

### Exemplary Embodiment

Below, an example of an embodiment of the present disclosure is described with reference to the drawings. In the drawings, structural elements and portions that are the same or equivalent are assigned the same reference symbols. Dimensional proportions in the drawings may be exaggerated for convenience of description and may be different from actual proportions.

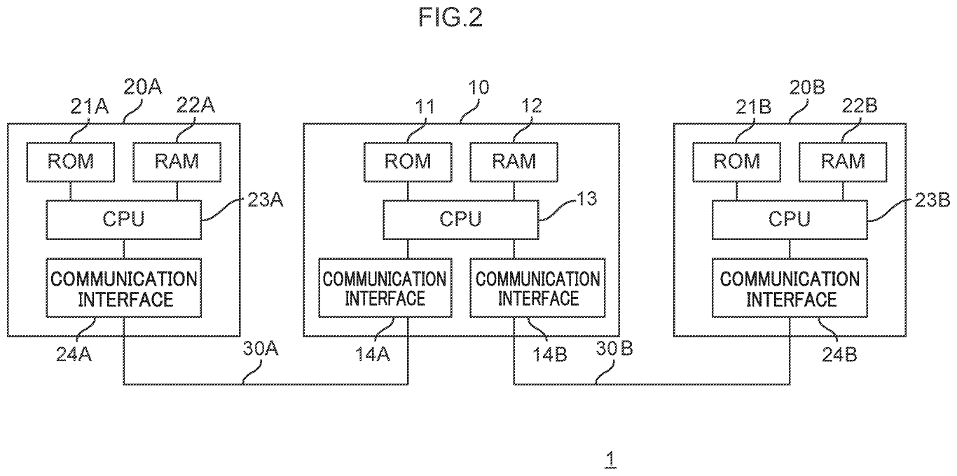

FIG. 2 is a diagram showing schematic structures of a communication system according to the present exemplary embodiment. A communication system 1 shown in FIG. 2 is, for example, a communication system provided in a vehicle. The communication system 1 is provided with a relay device 10 and ECUs 20A and 20B. The relay device 10 and ECU 20A are connected by a communication line 30A, and the relay device 10 and ECU 20B are connected by a communication line 30B. The communication lines 30A and 30B are, for example, LAN cables. FIG. 2 shows only the two ECUs 20A and 20B, but the number of ECUs may be three or more.

The relay device 10 is a device that relays communications between the ECUs 20A and 20B. The relay device 10 includes read-only memory (ROM) 11, random access memory (RAM) 12, a central processing unit (CPU) 13, and communication interfaces 14A and 14B.

The ROM 11 stores various programs and various kinds of data. The RAM 12 serves as a workspace, temporarily memorizing programs and data. The CPU 13, which is an example of a hardware processor, is a central arithmetic processing unit that executes various programs and controls respective parts. That is, the CPU 13 loads a program from the ROM 11, which is an example of memory, and executes the program, using the RAM 12 as a workspace. The CPU 13 implements control of the structures described above and various kinds of computational processing in accordance with programs recorded at the ROM 11. In the present exemplary embodiment, a communication program for communication processing in the communication system 1 is stored at the ROM 11.

The communication interface 14A is an interface for communicating with the ECU 20A and uses, for example, a wired communications standard such as Ethernet or the like. The communication interface 14B is an interface for communicating with the ECU 20B and uses, for example, a wired communications standard such as Ethernet or the like.

The ECU 20A includes ROM 21A, RAM 22A, a CPU 23A and a communication interface 24A. Similarly, the ECU 20B includes ROM 21B, RAM 22B, a CPU 23B and a communication interface 24B. Hardware structures of the ECU 20A are now described.

The ROM 21A stores various programs and various kinds of data. The RAM 22A serves as a workspace, temporarily memorizing programs and data. The CPU 23A, which is an example of a hardware processor, is a central arithmetic processing unit that executes various programs and controls respective parts. That is, the CPU 23A loads a program from the ROM 21A, which is an example of memory, and executes the program, using the RAM 22A, which is an example of the memory, as a workspace. The CPU 23A implements control of the structures described above and various kinds of computational processing in accordance with programs recorded at the ROM 21A. In the present exemplary embodiment, a communication program for conducting communications with other ECUs is stored at the ROM 21A.

The communication interface 24A is an interface for communicating with the relay device 10 and uses, for example, a wired communications standard such as Ethernet or the like.

When an above-mentioned communication program is executed, the relay device 10 uses the hardware resources described above to realize various functions. When other above-mentioned communication programs are executed, the ECUs 20A and 20B use the hardware resources described above to realize various functions. Functional structures realized by the relay device 10 and the ECUs 20A and 20B are now described.

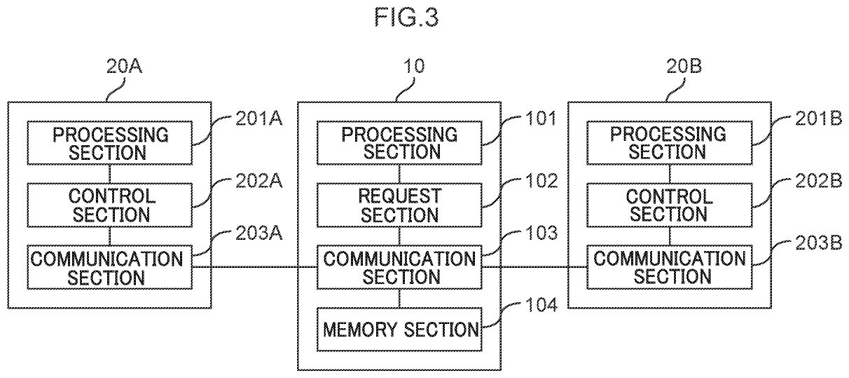

FIG. 3 is a block diagram showing an example of functional structures of the relay device 10 and the ECUs 20A and 20B.

As shown in FIG. 3, as functional structures, the relay device 10 includes a processing section 101, a request section 102, a communication section 103 and a memory section 104. The functional structures are realized by the CPU 13 reading and executing the communication program memorized at the ROM 11.

When a communication rate of wired communications with the ECU 20A or 20B is to be changed, the processing section 101 performs reset processing in relation to wired communication between the relay device 10 and the ECU 20A or 20B. Changes in the communication rate include both a change to lower the communication rate and a change to raise the communication rate that has been lowered. In the descriptions below, descriptions are given with the ECU 20A corresponding to a first device of the present disclosure and the ECU 20B corresponding to a second device of the present disclosure. The reset processing performed by the processing section 101 is hardware reset processing in the present exemplary embodiment, but the reset processing of the present disclosure may be software reset processing.

A condition for performing the reset processing at the processing section 101 is that a rate of occurrence of communication errors in wired communication with the ECU 20A exceeds a predetermined threshold. More specifically, the processing section 101 uses a case of a sum of a rate of occurrence of communication errors measured at the relay device 10 and a rate of occurrence of communication errors measured at the ECU 20A exceeding a predetermined threshold as a condition for performing reset processing. Accordingly, the processing section 101 measures a number of communication errors occurring in communications with the ECU 20A, and the processing section 101 acquires, via the communication section 103, information on a rate of occurrence of communication errors measured at the ECU 20A. The processing section 101 uses, for example, an error detection code such as CRC16 or the like to measure the number of errors occurring in communications with the ECU 20A. A range of time in which the rate of occurrence of communication errors is measured is not limited to a particular range.

When the reset processing relating to wired communication between the relay device 10 and the ECU 20A is performed by the processing section 101, the request section 102 makes a request to the ECU 20B to suppress fault detection (diagnostics) that detects when communication with the ECU 20A is not possible. More specifically, the request section 102 gives notice to the ECU 20B of a specification (below referred to as a diagnostics mask) specifying that, even if required data cannot be received from the ECU 20A, this should not be treated as a fault. The notice sent from the request section 102 is transmitted to the notice destination device by the communication section 103. Methods for preventing treatment as a fault include, for example, a method of not conducting fault detection, a method of not recording a fault as a diagnostic even when fault detection is conducted and a fault is identified, and the like.

When the request section 102 gives notice to the ECU 20B of the specification of the diagnostics mask, the request section 102 may give notice of a period until the diagnostics mask is to be removed. Information of this period may be information of an absolute time, and may be information of a relative time measured from the time at which the diagnostics mask is commenced. When the request section 102 gives notice to the ECU 20B of the specification of the diagnostics mask, the request section 102 may give notice so as to raise a threshold for treating errors as a fault. That is, the request section 102 may give notice to the ECU 20B such that a number of incidences of communication errors to be treated as a fault is greater when the diagnostics mask is specified than when the diagnostics mask is not specified.

The communication section 103 implements communications of messages to and from the ECUs 20A and 20B. The communication section 103 conducts communications with the ECUs 20A and 20B at plural communication rates. The communication section 103 may temporarily memorize messages received from the ECUs 20A and 20B at the memory section 104.

As shown in FIG. 3, as functional structures, the ECU 20A includes a processing section 201A, a control section 202A and a communication section 203A. These functional structures are realized by the CPU 23A reading and executing the communication program memorized at the ROM 21A. The ECU 20B has the same structures as the ECU 20A, but only the functional structures of the ECU 20A are described here.

When the communication rate of communications with the relay device 10 is to be changed, the processing section 201A performs reset processing in relation to communication between the ECU 20A and the relay device 10. Changes in the communication rate include both the change to lower the communication rate and the change to raise the communication rate that has been lowered. The reset processing performed by the processing section 201A is hardware reset processing in the present exemplary embodiment, but the reset processing of the present disclosure may be software reset processing.

A condition for performing the reset processing at the processing section 201A is that a rate of occurrence of communication errors in communication with the relay device 10 exceeds a predetermined threshold. Accordingly, the processing section 201A measures a number of communication errors occurring in communications with the relay device 10. Then the processing section 201A transmits information on the rate of occurrence of communication errors in communications with the relay device 10 to the relay device 10 via the communication section 203A. The processing section 201A uses, for example, an error detection code such as CRC16 or the like to measure the number of errors occurring in communications with the relay device 10.

When the reset processing in relation to communication between the relay device 10 and the ECU 20A is performed by the processing section 201A and the communication rate is lowered, the control section 202A selects priority messages for communicating with other ECUs in advance. Priority messages may differ in accordance with equipment or systems at which the communication system 1 is employed. For example, when the communication system 1 is provided in a vehicle, messages relating to safe running of the vehicle may be selected as priority messages.

The communication section 203A implements communication of messages to and from the relay device 10. The communication section 203A conducts communication with the relay device 10 at plural communication rates.

Now, operation of the relay device 10 and the ECUs 20A and 20B is described.

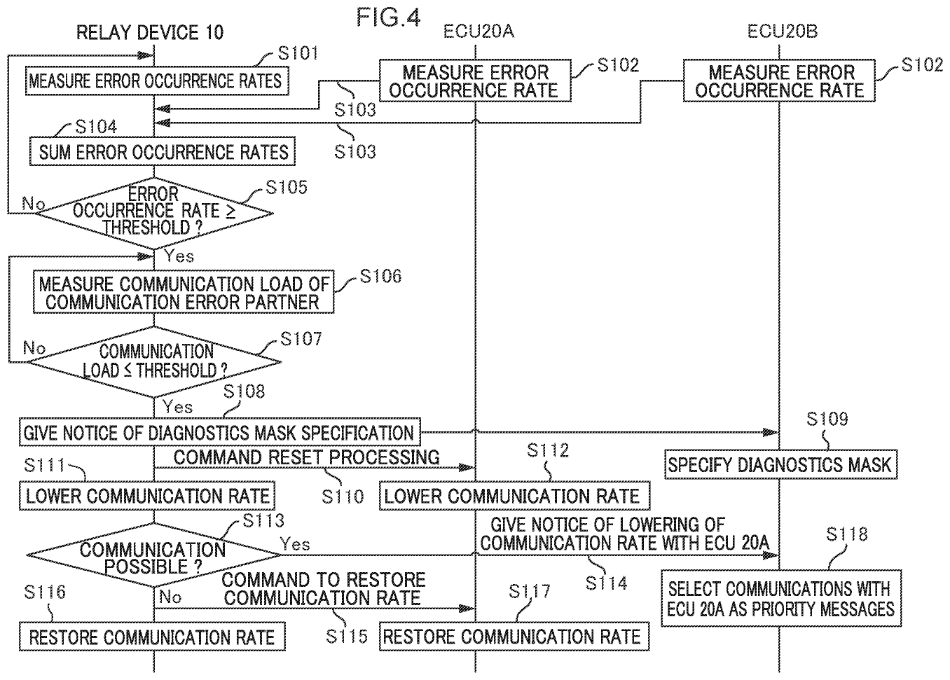

FIG. 4 is a flowchart showing flows of communication processing by the relay device 10 and the ECUs 20A and 20B. The CPU 13 loads the communication program from the ROM 11 into the RAM 12 and executes the program, and the CPUs 23A and 23B load the respective communication programs from the ROMs 21A and 21B into the RAMs 22A and 22B and execute the programs. Thus, the communication processing is performed.

In step S101, the relay device 10 measures rates of occurrence of communication errors in communications with the connected ECUs 20A and 20B. In step S102, the ECUs 20A and 20B measure rates of occurrence of communication errors in communications with the connected relay device 10. In step S103, the ECUs 20A and 20B periodically transmit information on the rates of occurrence of communication errors to the relay device 10.

When the relay device 10 receives the information on rates of occurrence of communication errors that is sent from the ECUs 20A and 20B, in step S104 the relay device 10 sums the respective rates of occurrence of communication errors of the ECUs 20A and 20B.

Then, in step S105, the relay device 10 makes a determination as to whether a rate of occurrence of communication errors summed in step S104 is at least a predetermined threshold value. When the rates of occurrence of communication errors are less than the predetermined threshold (“No” in step S105), the relay device 10 returns to step S101 and measures the rates of occurrence of communication errors in communications with the connected ECUs 20A and 20B. On the other hand, when a rate of occurrence of communication errors is equal to or greater than the predetermined threshold (“Yes” in step S105), then in step S106 the relay device 10 measures a communication load of a communication partner for which the rate of occurrence of communication errors is at least the predetermined threshold. In this example, it is assumed that the rate of occurrence of communication errors is equal to or greater than the predetermined threshold in communications with the ECU 20A.

Then, in step S107, the relay device 10 makes a determination as to whether the communication load measured in step S106 is equal to or less than a predetermined threshold value. The reason for determining whether or not the communication load is at most this predetermined threshold is that if reset processing is executed in a state in which a communication load is high, all messages being communicated are at risk of loss. When the communication load is not equal to or less than the predetermined threshold (“No” in step S107), the relay device 10 returns to step S106 and measures a communication load of another communication partner for which the rate of occurrence of communication errors is more than the predetermined threshold. On the other hand, when the communication load is equal to or less than the predetermined threshold thereof (“Yes” in step S107), in step S108 the relay device 10 gives notice to the ECU 20B of the specification of the diagnostics mask. In step S109, the ECU 20B specifies the diagnostics mask in accordance with the diagnostics mask specification notified from the relay device 10.

When the relay device 10 gives notice to the ECU 20B of the specification of the diagnostics mask, the relay device 10 may give notice of a period until the diagnostics mask is to be removed. Information of this period may be information of an absolute time, and may be information of a relative time measured from the time at which the diagnostics mask is commenced. When the relay device 10 gives notice to the ECU 20B of the specification of the diagnostics mask, the relay device 10 may give notice so as to raise a threshold for treating errors as a fault. That is, the relay device 10 may give notice to the ECU 20B such that a number of incidences of communication errors to be treated as a fault is greater when the diagnostics mask is specified than when the diagnostics mask is not specified.

Then, in step S110, the relay device 10 commands the execution of reset processing in order to lower a communication rate with the ECU 20A.

In step S111, the relay device 10 executes the reset processing and lowers the communication rate of communications with the ECU 20A from the communication rate before the reset processing. In step S112, the ECU 20A executes reset processing in response to the command from the relay device 10 and lowers the communication rate of communications with the relay device 10 from the communication rate before the reset processing. The reset processing in step S111 and step S111 is hardware reset processing in the present exemplary embodiment. However, the present disclosure is not limited to hardware reset processing; software reset processing may be performed.

After step S111, in step S113 the relay device 10 makes a determination as to whether communications with the ECU 20A are possible at the lowered communication rate. The relay device 10 makes the determination as to whether communications with the ECU 20A are possible at the lowered communication rate by, for example, linking up. When the result of this determination is that communications with the ECU 20A are possible at the lowered communication rate (“Yes” in step S113), then in step S114 the relay device 10 gives notice to the ECU 20B of the lowering of the communication rate with the ECU 20A. On the other hand, when the result of the determination is that communications with the ECU 20A are not possible at the lowered communication rate (“No” in step S113), then in step S115 the relay device 10 commands the ECU 20A to restore the communication rate with the ECU 20A to the original rate. After step S115, in step S116 the relay device 10 restores the communication rate of communications with the ECU 20A to the communication rate before the reset processing. In step S117, in response to the command from the relay device 10, the ECU 20A restores the communication rate of communications with the relay device 10 to the communication rate before the reset processing.

In step S113, notice of the lowering of the communication rate with the ECU 20A is sent from the relay device 10 to the ECU 20B. In step S118, the ECU 20B selects priority messages for communication with the ECU 20A and communicates these messages. The ECU 20B conducts communications with communication partners other than the ECU 20A (for example, an ECU other than the ECUs 20A and 20B) by usual communications.

Because the relay device 10 executes the sequence of processing shown in FIG. 4, a case of the ECU 20A that is executing reset processing being mistakenly detected as faulty by the ECU 20B may be suppressed. In the sequence of processing shown in FIG. 4, the relay device 10 gives notice of the specification of the diagnostics mask before the reset processing, but the relay device 10 may give notice of the specification of the diagnostics mask after the start of the reset processing.

When the communication system 1 is incorporated in an in-vehicle network, because the relay device 10 executes the sequence of processing shown in FIG. 4 and a case of the ECU 20B mistakenly detecting the ECU 20A as faulty is suppressed, the vehicle may smoothly switch into a limp-home mode in which the vehicle runs at low speed.

Now, flows of processing when the relay device 10 and ECU 20A raise the communication rate therebetween after the communication rate has been lowered are described.

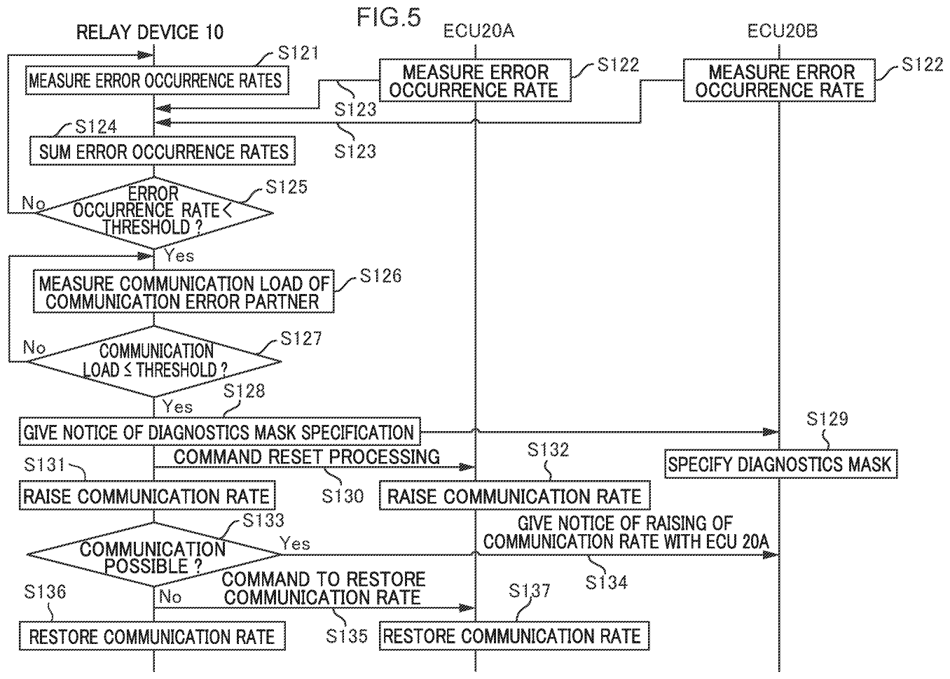

FIG. 5 is a flowchart showing flows of communication processing by the relay device 10 and the ECUs 20A and 20B. The CPU 13 loads the communication program from the ROM 11 into the RAM 12 and executes the program, and the CPUs 23A and 23B load the respective communication programs from the ROMs 21A and 21B into the RAMs 22A and 22B and execute the programs. Thus, the communication processing is performed.

In step S121, the relay device 10 measures rates of occurrence of communication errors in communications with the connected ECUs 20A and 20B. In step S122, the ECUs 20A and 20B measure respective rates of occurrence of communication errors in communications with the connected relay device 10. In step S123, the ECUs 20A and 20B periodically transmit information on the rates of occurrence of communication errors to the relay device 10.

When the relay device 10 receives the information on rates of occurrence of communication errors that is sent from the ECUs 20A and 20B, in step S124, the relay device 10 sums the respective rates of occurrence of communication errors of the ECUs 20A and 20B.

Then, in step S125, the relay device 10 periodically makes a determination as to whether a rate of occurrence of communication errors summed in step S124 is less than a predetermined threshold value. Since the communication rate between the relay device 10 and the ECU 20A was lowered by the communication processing shown in FIG. 4, the rate of occurrence of communication errors may have improved. Accordingly, the relay device 10 executes the determination processing in step S125 periodically. When this rate of occurrence of communication errors is equal to or greater than the predetermined threshold (“No” in step S125), the relay device 10 returns to step S121 and measures the rates of occurrence of communication errors in communications with the connected ECUs 20A and 20B. On the other hand, when this rate of occurrence of communication errors is less than the predetermined threshold (“Yes” in step S125), then in step S126 the relay device 10 measures a communication load of a communication partner for which the rate of occurrence of communication errors is less than a predetermined threshold. In this example, it is assumed that the rate of occurrence of communication errors is less than the predetermined threshold in communications with the ECU 20A.

Then, in step S127, the relay device 10 makes a determination as to whether the communication load measured in step S126 is equal to or less than a predetermined threshold value. The reason for determining whether or not the communication load is at most this predetermined threshold is that if reset processing is executed in a state in which a communication load is high, all messages being communicated are at risk of loss. When the communication load is not equal to or less than the predetermined threshold (“No” in step S127), the relay device 10 returns to step S126 and measures a communication load of another communication partner for which the rate of occurrence of communication errors is at least the predetermined threshold. On the other hand, when the communication load is equal to or less than the predetermined threshold thereof (“Yes” in step S127), in step S128 the relay device 10 gives notice to the ECU 20B of the specification of the diagnostics mask. In step S129, the ECU 20B specifies the diagnostics mask in accordance with the specification of the diagnostics mask notified from the relay device 10.

Then, in step S130, the relay device 10 commands the execution of reset processing in order to raise the communication rate with the ECU 20A.

In step S131, the relay device 10 executes the reset processing and raises the communication rate of communications with the ECU 20A from the communication rate before the reset processing. In step S132, the ECU 20A executes reset processing in response to the command from the relay device 10 and raises the communication rate of communications with the relay device 10 from the communication rate before the reset processing. The reset processing in step S131 and step S132 is hardware reset processing in the present exemplary embodiment. However, the present disclosure is not limited to hardware reset processing; software reset processing may be performed.

After step S131, in step S133 the relay device 10 makes a determination as to whether communications with the ECU 20A are possible at the raised communication rate. The relay device 10 makes the determination as to whether communications with the ECU 20A are possible at the raised communication rate by, for example, linking up. When the result of this determination is that communications with the ECU 20A are possible at the raised communication rate (“Yes” in step S133), then in step S134 the relay device 10 gives notice to the ECU 20B of the raising of the communication rate with the ECU 20A. On the other hand, when the result of the determination is that communications with the ECU 20A are not possible at the raised communication rate (“No” in step S133), then in step S135 the relay device 10 commands the ECU 20A to restore the communication rate with the ECU 20A to the original rate. After step S135, in step S136 the relay device 10 restores the communication rate of communications with the ECU 20A to the communication rate before the reset processing. In step S137, in response to the command from the relay device 10, the ECU 20A restores the communication rate of communications with the relay device 10 to the communication rate before the reset processing.

Because the relay device 10 executes the sequence of processing shown in FIG. 5, a case of the ECU 20A that is conducting reset processing being mistakenly detected as faulty by the ECU 20B may be suppressed. In the sequence of processing shown in FIG. 5, the relay device 10 gives notice of the specification of the diagnostics mask before the reset processing, but the relay device 10 may give notice of the specification of the diagnostics mask after the start of the reset processing.

When the communication system 1 is incorporated in an in-vehicle network, because the relay device 10 executes the sequence of processing shown in FIG. 5 and a case of the ECU 20B mistakenly detecting the ECU 20A as faulty is suppressed, the vehicle may smoothly switch into the limp-home mode in which the vehicle runs at low speed.

The processing that, in the exemplary embodiment described above, is executed by CPUs reading software (programs) may be executed by various kinds of processor other than a CPU. Examples of processors in these cases include a PLD (programmable logic device) in which a circuit configuration can be modified after fabrication, such as an FPGA (field programmable gate array) or the like, a dedicated electronic circuit which is a processor with a circuit configuration that is specially designed to execute specific processing, such as an ASIC (application-specific integrated circuit) or the like, and so forth. The communication processing may be executed by one of these various kinds of processors, and may be executed by a combination of two or more processors of the same or different kinds (for example, plural FPGAs, a combination of a CPU with an FPGA, or the like). Hardware structures of these various kinds of processors are, to be more specific, electronic circuits combining circuit components such as semiconductor components and the like.

In the exemplary embodiment described above, a mode is described in which the communication processing program is memorized in advance (installed) at a ROM, but this is not limiting. The program may be provided in a mode recorded on a non-transitory recording medium, such as a CD-ROM (compact disc read-only memory), DVD-ROM (digital versatile disc read-only memory), USB (universal serial bus) memory or the like. Modes are also possible in which a program is downloaded from external equipment via a network.

An object of the present disclosure is to provide a relay device, a communication control method and a recording medium recording a communication program that may, when reset processing is being performed at a communication device, prevent detection of an error by another communication device.

A first aspect of the present disclosure is a relay device that inculudes a memory, and a processor coupled to the memory, the processor being configured to: perform reset processing in relation to wired communication with a first device in response to a change in a communication rate of the wired communication with the first device; and in response to performing the reset processing, make a request to a second device to suppress processing relating to fault detection that detects cases in which communication between the second device and the first device is not possible.

According to the first aspect of the present disclosure, because suppression of the processing relating to fault detection by the second device is requested when the reset processing is performed at the first device, detection of an error by the second device may be prevented.

A second aspect of the present disclosure is the relay device according to the first aspect, wherein the processor is configured to make the request to the second device to suppress the processing relating to fault detection before starting the reset processing.

According to the second aspect of the present disclosure, because the suppression of the processing relating to fault detection by the second device is requested before the reset processing at the first device is started, detection of an error by the second device may be prevented.

A third aspect of the present disclosure is the relay device according to the first aspect, wherein the processor is configured to make the request to the second device to suppress the processing relating to fault detection after starting the reset processing.

According to the third aspect of the present disclosure, because the suppression of the processing relating to fault detection by the second device is requested, even though after the reset processing at the first device is started, detection of an error by the second device may be prevented.

A fourth aspect of the present disclosure is the relay device according to any of the first to the third aspects, wherein the reset processing is hardware reset processing.

According to the fourth aspect of the present disclosure, because messages that are expected to be sent from the first device reach the second device even when hardware reset processing is being performed at the first device, detection of an error by the second device may be prevented.

A fifth aspect of the present disclosure is the relay device according to any of the first to the fourth aspects, wherein the processor is configured to, at a time when the reset processing is completed, give notice to the second device of ending of the suppression of the processing relating to fault detection.

According to the fifth aspect of the present disclosure, because notice of the ending of the suppression of the processing relating to fault detection is given when the reset processing at the first device is completed, a fault may be accurately detected by the second device when an error actually occurs.

A sixth aspect of the present disclosure is the relay device according to any of the first to the fifth aspects, wherein the processor is configured to, in response to performing the reset processing, give notice to the connected second device that the communication rate between the relay device and the first device is being lowered.

According to the sixth aspect of the present disclosure, a lowering of the communication rate with the first device may be recognized at the second device.

A seventh aspect of the present disclosure is the relay device according to any of the first to the sixth aspects, wherein the processor is configured to perform the reset processing in a case in which a communication load of the wired communication with the first device is equal to or less than a predetermined threshold.

According to the seventh aspect of the present disclosure, during the reset processing, loss of all messages being communicated by wired communication with the first device may be prevented.

An eighth aspect of the present disclosure is the relay device according to any of the first to the seventh aspects, wherein the relay device is provided in a vehicle.

According to the eighth aspect of the present disclosure, in a network in a vehicle, because messages from the first device reach the second device even when the reset processing is being performed at the first device, detection of an error by the second device may be prevented.

A ninth aspect of the present disclosure is a communication control method that includes: by a processor, performing reset processing in relation to wired communication with a first device in response to a change in a communication rate of the wired communication with the first device; and in response to performing the reset processing, making a request to a second device to suppress processing relating to fault detection that detects cases in which communication between the second device and the first device is not possible.

According to the ninth aspect of the present disclosure, because suppression of the processing relating to fault detection by the second device is requested when the reset processing is performed at the first device, detection of an error by the second device may be prevented.

A tenth aspect of the present disclosure is a non-transitory computer-readable recording medium storing a communication program executable by a computer to perform processing that includes: performing reset processing in relation to wired communication with a first device in response to a change in a communication rate of the wired communication with the first device; and in response to performing the reset processing, making a request to a second device to suppress processing relating to fault detection that detects cases in which communication between the second device and the first device is not possible.

According to the tenth aspect of the present disclosure, because suppression of the processing relating to fault detection by the second device is requested when the reset processing is performed at the first device, detection of an error by the second device may be prevented.

According to the present disclosure, a relay device, a communication control method and a recording medium recording a communication program may be provided that, by suppressing detection of an error by another communication device when reset processing is being performed at a communication device, prevent detection of errors by the another communication device.

What is claimed is:

1. A relay device comprising
a memory, and
a processor coupled to the memory,
the processor being configured to:
perform reset processing in relation to wired communication with a first device in response to a change in a communication rate of the wired communication with the first device; and
in response to performing the reset processing, make a request to a second device to suppress processing relating to fault detection that detects cases in which communication between the second device and the first device is not possible.

2. The relay device according to claim 1, wherein the processor is configured to make the request to the second device to suppress the processing relating to fault detection before starting the reset processing.

3. The relay device according to claim 1, wherein the processor is configured to make the request to the second device to suppress the processing relating to fault detection after starting the reset processing.

4. The relay device according to claim 1, wherein the reset processing is hardware reset processing.

5. The relay device according to claim 1, wherein the processor is configured to, at a time when the reset processing is completed, give notice to the second device of ending of the suppression of the processing relating to fault detection.

6. The relay device according to claim 1, wherein the processor is configured to, in response to performing the reset processing, give notice to the connected second device that the communication rate between the relay device and the first device is being lowered.

7. The relay device according to claim 1, wherein the processor is configured to perform the reset processing in a case in which a communication load of the wired communication with the first device is equal to or less than a predetermined threshold.

8. The relay device according to claim 1, wherein the relay device is provided in a vehicle.

9. A communication control method comprising:
by a processor,
performing reset processing in relation to wired communication with a first device in response to a change in a communication rate of the wired communication with the first device; and
in response to performing the reset processing, making a request to a second device to suppress processing relating to fault detection that detects cases in which communication between the second device and the first device is not possible.

10. The communication control method according to claim 9, wherein the request is made to the second device to suppress the processing relating to fault detection before starting the reset processing.

11. The communication control method according to claim 9, wherein the request is made to the second device to suppress the processing relating to fault detection after starting the reset processing.

12. A non-transitory computer-readable recording medium storing a communication program executable by a computer to perform processing comprising:
performing reset processing in relation to wired communication with a first device in response to a change in a communication rate of the wired communication with the first device; and
in response to performing the reset processing, making a request to a second device to suppress processing relating to fault detection that detects cases in which communication between the second device and the first device is not possible.

13. The non-transitory computer-readable recording medium according to claim 12, wherein the request is made to the second device to suppress the processing relating to fault detection before starting the reset processing.

14. The non-transitory computer-readable recording medium according to claim 12, wherein the request is made to the second device to suppress the processing relating to fault detection after starting the reset processing.
